(19) United States
(12) Patent Application Publication
(10) Pub. No.: US 2006/0020617 A1
(43) Pub. Date: Jan. 26, 2006

(54) Method for processing data packets in a data network which has a mobile function

(75) Inventors: Jochen Grimminger, Munchen (DE); Wolfgang Groting, Oberhausen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/535,200

(22) PCT Filed: Nov. 13, 2003
(86) PCT No.: PCT/EP03/12716

§ 371 Date: May 17, 2005

(30) Foreign Application Priority Data
Nov. 18, 2002 (DE) 10253714.3

(51) Int. Cl. G06F 17/00

(52) U.S. Cl. 707/102

(57) ABSTRACT

The invention relates to a method for processing data packets in a data network which has a mobile function. A terminal and a data source use a first network protocol, according to which addresses of the first network protocol, reproduced in a first format are assigned to the terminal and the data source. A second network protocol is used in the data network, according to which addresses of a second network protocol, reproduced in a second format are assigned to computers in the data network. The terminal is assigned to a home network and receives in said network a home address of the first network protocol, reproduced in a first format. The terminal also receives a second address of the second network protocol, reproduced in a second format. A data packet, comprising the home address, reproduced in the first format as the source address and the address of the data source, reproduced in the first format as the target address, is adapted in such a way that said packet contains the second address, reproduced in the second format as the source address and the address of the home computer, reproduced in the second format as the target address, in addition to the address of the data source, reproduced in the second format as an additional address.

### CLAIM FOR PRIORITY

This application is a national stage of PCT/EP2003/012716, published in the German language on Nov. 13, 2003, which claims the benefit of priority to German Application No. 102 53 714.3, filed on Nov. 18, 2002.

### TECHNICAL FIELD OF THE INVENTION

The invention relates to a method for processing data packets in a data network which has a mobile function, and to a corresponding data network and a data transmission device.

### BACKGROUND OF THE INVENTION

In the case of data networks which have a mobile function, provision is made for a mobile terminal, e.g. a laptop or a PDA which is known in a home network, to move into an external network, wherein it is further ensured that data which is sent to the mobile terminal arrives at said mobile terminal.

A multiplicity of protocols which allow data networks having a mobile function are already known, e.g. the Internet protocol IPv4 with Mobile-Ipv4 support or the Internet protocol IPv6 with Mobile-Ipv6 support.

In data networks without a mobile function, transmission mechanisms are known which allow communication between computers that use different network protocols. In particular, the protocol translation mechanism NAT-PT (Network Address Translation—Protocol Translation) is known, which allows translation of addresses of the IPv4 protocol into addresses of the IPv6 protocol. This known mechanism is not designed for data networks having a mobile function and furthermore has several known disadvantages such as e.g. inadequate network security.

WO 01/41395 discloses a method and an arrangement in which the packets of a network protocol are encapsulated in packets of a different network protocol. In particular, the teaching thus suggests a tunneling of IPv6 packets within IPv4 packets.

### SUMMARY OF THE INVENTION

The invention establishes a method for processing data packets in a data network which has a mobile function, which method allows the use of different network protocols in addition to the mobile function.

In a first embodiment, the method is used for processing data packets which must be transmitted in a data network which has a mobile function from a terminal to a data source via a home computer of the data network. In this context, the terminal and the data source use a first network protocol, in which addresses of the first network protocol are assigned to the terminal and the data source, the addresses being represented in a first format. In contrast, a second network protocol is used in the data network, in which addresses of a second network protocol are assigned to the computers in the data network, the addresses being represented in a second format, wherein the addresses of the first network protocol can also be represented in the second format. In accordance with the method, the terminal is assigned to a home network and the terminal in the home network receives a home address of the first network protocol, said home address being represented in the first format. The terminal also receives a second address of the second network protocol, said second address being represented in the second format, wherein the second address is the address in an external network outside of the home network if the terminal is situated in the external network. In the processing step of the method, which step is designated as the first processing step, a data packet including the home address represented in the first format as a source address and the address of the data source represented in the first format as a destination address is adapted in such a way that the adapted data packet contains the second address represented in the second format as a source address and the address of the home computer represented in the second format as a destination address as well as the address of the data source represented in the second format as a further address. As a result of this processing, a conversion of the addresses of a data packet from a first network protocol into a second network protocol is provided, wherein the converted addresses ensure that the data packet is forwarded to the home computer in the data network which has a mobile function. The correct routing of the data packet is therefore guaranteed.

In a particularly preferred embodiment of the invention, a so-called dual-stacked computer is used as a home computer, said dual-stacked computer being capable of processing both data packets of the first network protocol and data packets of the second network protocol. When using such a home computer, the terminal is assigned the home address of the first network protocol represented in the second format by the home computer, wherein the home address is then converted into the first format in a conversion step. In a particularly preferred embodiment, the first processing step and/or the conversion step in the claimed method is carried out in this context by a data transmission device which is connected to the terminal. The data transmission device therefore takes over the processing of the data packets independently of the terminal. In this context, the data packets which are processed are preferably transmitted via a PPP connection (point-to-point protocol) from the terminal to the data transmission device.

In order to ensure that the data packets which are processed in the first processing step are also correctly forwarded to the data source, a further second processing step is preferably carried out. In this processing step, the data packet which was adapted in the first processing step is changed in such a way that the changed data packet includes the home address represented in the first format as a source address and the address of the data source represented in the first format as a destination address, wherein the address of the data source represented in the first format is determined from the further address of the data packet which was adapted in the first processing step. In this way, data packets are produced again which can be processed by the first network protocol, i.e. in particular by the data source. In this context, it is preferable for the data packet which was adapted in the first processing step to be transmitted via the data network to the home computer and for the second processing step to be carried out by the home computer, wherein an assignment of the second address of the terminal to the home address is stored for the processing step in the home computer. The data packet which was changed in the second processing step is then transmitted to the data source.

In a preferred embodiment, the first network protocol is IPv4 with or without Mobile-IPv4 support and the second network protocol is IPv6 with Mobile-Ipv6 support or the first network protocol is IPv6 with Mobile-Ipv6 support and the second network protocol is IPv4 with or without Mobile-IPv4 support.

A second embodiment of the method relates to a method for processing data packets which are transmitted in a data network which has a mobile function from a data source to a terminal via a home computer of the data network. In contrast to the method of the first embodiment, the data is transmitted in the opposite direction in this method. For this, in a first processing step of the method, a data packet including the address of the data source represented in the first format as a source address and the home address represented in the first format as a destination address is adapted in such a way that the adapted data packet contains the address of the home computer represented in the second format as a source address and the second address of the terminal represented in the second format as a destination address as well as the address of the data source represented in the second format as a further address. This has the result of ensuring a conversion of the addresses of the first network protocol into the addresses of the second network protocol. Furthermore, the correct routing of the data packet in the data network is guaranteed.

In a preferred embodiment, the data packet which is adapted is transferred from the data source to the home computer and the first processing step is carried out by the home computer, wherein an assignment of the second address to the home address of the terminal is stored for the processing step in the home computer.

In a second processing step, the data packet which was adapted in the first processing step is preferably changed in such a way that the changed data packet includes the address of the data source represented in the first format as a source address and the home address represented in the first format as a destination address, wherein the address of the data source represented in the first format is determined from the further address of the data packet which was adapted in the first processing step. A correct routing of the data packet to the terminal is thereby guaranteed.

In particular, the data packet which was adapted in the first processing step is transmitted via the data network from the home computer to a data transmission device which is connected to the terminal and the second processing step is carried out by the data transmission device, wherein the data packet which was changed in the second processing step is then transmitted from the data transmission device to the terminal. Consequently, a part of the functionality of the processing method is taken over by a separate data transmission device which is not a component of the terminal. The terminal can therefore be disconnected from the processing method, wherein processed data packets are forwarded via a connection between data transmission device and terminal.

The connection between data transmission device and terminal in this case can be a PPP connection (point-to-point protocol), for example, which is easy to manage.

Analogously to the method of the first embodiment, in a preferred embodiment of the method of the second embodiment, the first network protocol is IPv4 with or without Mobile-IPv4 support and the second network protocol is IPv6 with Mobile-Ipv6 support or the first network protocol is IPv6 with Mobile-Ipv6 support and the second network protocol is IPv4 with or without Mobile-IPv4 support. Furthermore, the further address of the data packet which was adapted in the first processing step is preferably stored in the routing header of the data packet.

In addition to the method that is described above for processing data packets, the invention also relates to a data transmission device which is configured in such a way that both the first processing step in accordance with the first embodiment of the method and the first processing step in accordance with the second embodiment of the method can be carried out using this device. In this way, provision is made for a separate data transmission device which provides the essential functionalities of the data processing method independently of the terminal. In particular the data transmission device can be a mobile device, in particular a mobile radio device, by means of which a connection to a data network can be established easily.

The invention also relates to a data network which has a mobile function for transmitting data between data sources and terminals, wherein the data network is configured in such a way that a method in accordance with the first embodiment of the invention and a method in accordance with the second embodiment of the invention can be carried out. In such a data network, the home network and/or the external network is preferably a wireless network which is based on GPRS and/or Wireless LAN and/or Bluetooth and/or UMTS and/or CDMA2000 in particular. Moreover, a part of the data network is preferably the Internet.

### BRIEF DESCRIPTION OF THE INVENTION

Exemplary embodiments of the invention are explained and illustrated below with reference to the drawings in which:

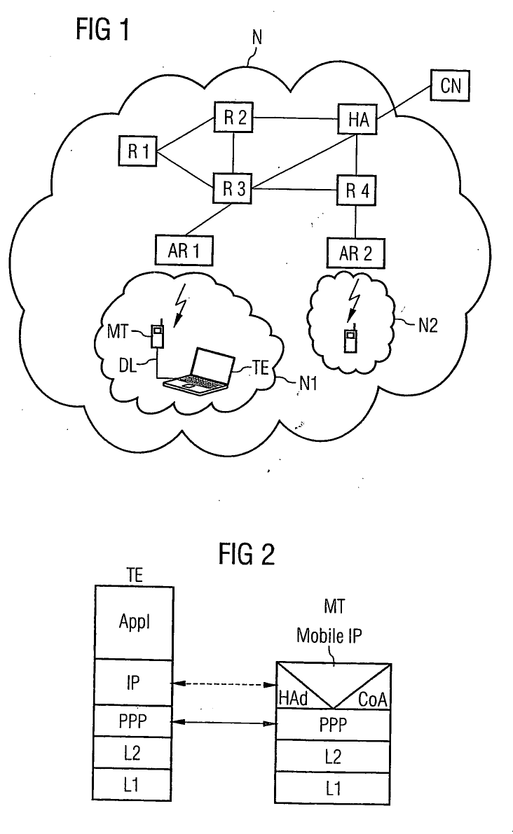

FIG. 1 shows a data network in which the data processing method can be carried out.

FIG. 2 shows the protocol layers which are processed in the terminal and in the data transmission device.

### DETAILED DESCRIPTION OF THE INVENTION

The data network N which is illustrated in FIG. 1 includes a home computer HA (HA=Home Agent), a plurality of routers R1 to R4 and access routers AR1 and AR2 (AR=Access Router). The two access routers AR1 and AR2 are in turn connected to subnetworks N1 and N2, which are two different mobile radio networks. The subnetwork N1 is the home network of one terminal TE (TE=Terminal End Device), which is preferably a mobile device such as a laptop, for example. The terminal TE is connected to a mobile data transmission terminal MT (MT=Mobile Terminal) via a data line DL, wherein the data transmission device is logged into the subnetwork N1.

The data network N is also connected to a data source CN, wherein data is exchanged between the terminal TE and the data source CN via the data network N. The data network N is a data network which has a mobile function, and is preferably a Mobile-IPv6 data network. In such a data network the data is sent in the form of data packets, wherein the source addresses and destination addresses of the data packets are stored in the headers of the data packets. The mobile function of the data network ensures that the terminal TE which is situated in the home network N1 can also switch to the external network N2, said external network being located outside of the home network, and that provision is made for forwarding the data packets to the terminal that is situated in the external network. This is achieved by routing data from the data source CN, which data is sent to the terminal TE, via the home computer HA, wherein the home computer modifies the data in such a way that it also reaches an external network. In the data network in FIG. 1, specific processing steps of the method are carried out in the data transmission device MT as explained below. However, it is also conceivable that no additional data transmission device is used and the processing steps which are carried out by the data transmission device are carried out directly in the terminal.

The method is exemplified below for the case in which the data network N is a Mobile-IPv6 network (subsequently abbreviated as MIPv6), whereas the data source CN and the terminal TE use the Internet protocol IPv4.

If the data transmission device MT is located in the home network, it requests a home address from the home computer HA of the data network. An IPv4 address which is written in MIPv6 format is used as a home address here. The IPv4 address is in turn converted by the data transmission device MT into the IPv4 format and assigned to the terminal TE. During the data transmission of a data packet from the terminal to the data source, the terminal firstly generates a data packet which contains the IPv4 home address in the IPv4 format as a source address and the IPv4 address of the data source CN in the IPv4 format as a destination address in the header. The data packet is firstly routed to the data transmission device MT via the data connection DL. As part of this activity, the data transmission device is assigned an MIPv6 second address CoA in the MIPv6 format, wherein the second address is an external address in an external network if the data transmission device is located in an external network. The data transmission device converts the data packet header of the data packet into an MIPv6 header. The converted header includes an MIPv6 external address CoA in the MIPv6 format as a source address and the MIPv6 address of the home computer in the MIPv6 format as a destination address. Furthermore, a routing header RH is generated, which contains the IPv4 address of the data source in the MIPv6 format. The payload of the data packet and further header options remain unchanged.

This data packet is now routed in a usual way to the home computer. The home computer in turn converts the header of the data packet into a header which contains as a source address the home address in the IPv4 format. In order to achieve this, an assignment of the external address in the MIPv6 format to the home address in the IPv4 format is stored in the home computer. The destination address of the header which is converted by the home computer is the IPv4 address of the data source in IPv4 format. The data packet can then be transferred from the home computer HA to the data source CN via the IPv4 protocol.

When transporting a data packet from the data source CN to the terminal TE, the header which is generated by the data source CE includes the IPv4 address of the data source in the IPv4 format as a source address and the home address in the IPv4 format as a destination address. The data packet is then routed to the home computer and converted by said home computer into a data packet which includes the MIPv6 address of the home computer in the MIPv6 format as a source address and the external address CoA in the MIPv6 format as a destination address. Furthermore, a routing header is then generated which includes the IPv4 address of the data source CN in the MIPv6 format. The data packet which is generated in this way is then routed to the data transmission device MT via the data network. This data transmission device generates a new header. This new header includes the address of the data source CN in the IPv4 format, which address was determined via the routing header, as a source address. The header includes the home address in the IPv4 format as a destination address. This data packet can then be forwarded to the terminal TE via the data connection DL and processed further by the terminal.

FIG. 2 shows the protocol stacks which are processed by the terminal TE and the data transmission device MT. The protocol stack of the terminal comprises the physical layer L1, the L2 layer which governs the access to the transmission medium, a PPP layer for the data connection between the terminal and the data transmission device, an IP layer which can be any Internet protocol, and the application layer which is constructed thereupon. The data transmission device comprises the L1 layer, the L2 layer, the PPP layer and a Mobile-IP layer which can be any Mobile-IP protocol. In particular, the Mobile-IP layer contains the home address HAd and the address CoA in the external network. As indicated by the two double arrows between the two protocol stacks, the home address is assigned to the terminal via the PPP protocol and used in the IP protocol of the terminal.

What is claimed is:

1. A method for processing data packets which are transmitted in a data network which has a mobile function from a terminal to a data source via a home computer of the data network, wherein the terminal and the data source use a first network protocol, in which addresses of the first network protocol are assigned to the terminal and to the data source, the addresses being represented in a first format, and the data network uses a second network protocol, in which addresses of the second network protocol are assigned to the computers in the data network, the addresses being represented in a second format, wherein the addresses of the first network protocol can also be represented in the second format, comprising:
assigning the terminal to a home network, wherein the terminal in the home network receives a home address of the first network protocol, the home address being represented in the first format;
processing, using the home computer, addresses of the first and the second network protocol, wherein the home computer assigns the home address which is represented in the second format to the terminal and the home address is converted into the first format in a conversion step;
receiving at the terminal a second address of the second network protocol, the second address being represented in the second format, wherein the second address is the address in an external network outside of the home network the terminal is situated in the external network; and
adapting, a data packet, including the home address represented in the first format as a source address and the address of the data source represented in the first format as a destination address, such that the adapted data packet includes the second address represented in the second format as a source address and the address of the home computer represented in the second format as a destination address as well as the address of the data source represented in the second format as a further address.

2. The method as claimed in claim 1, in which the at least one of the adapting and conversion step is performed by a data transmission device which is connected to the terminal.

3. The method as claimed in claim 2, in which the data transmission device is connected to the terminal via a (point-to-point protocol) connection.

4. The method as claimed in claim 1, in which the data packet which was adapted is changed such that the changed data packet includes the home address represented in the first format as a source address and the address of the data source represented in the first format as a destination address, wherein the address of the data source represented in the first format is determined from the further address of the data packet which was adapted.

5. The method as claimed in claim 4, in which the data packet which was adapted is transmitted via the data network to the home computer and the changing of the data packet is performed by the home computer, wherein an assignment of the second address of the terminal to the home address is stored for the processing step in the home computer, and the data packet which was changed is then transmitted to the data source.

6. The method as claimed in claim 1, in which the first network protocol is IPv4 with or without Mobile-IPv4 support and the second network protocol is IPv6 with Mobile-IPv6 support, or in which the first network protocol is IPv6 with Mobile-IPv6 support and the second network protocol is IPv4 with or without Mobile-IPv4 support.

7. The method as claimed in claim 6, in which the further address of the data packet which was adapted in the processing step is stored in the routing header of the data packet.

8. A method for processing data packets which are transmitted in a data network which has a mobile function from a data source to a terminal via a home computer of the data network, wherein the terminal and the data source use a first network protocol, in which addresses of the first network protocol are assigned to the terminal and the data source, the addresses being represented in a first format, and the data network uses a second network protocol, in which addresses of the second network protocol are assigned to the computers in the data network, the addresses being represented in a second format, wherein the addresses of the first network protocol can also be represented in the second format, comprising:
assigning the terminal to a home network, wherein the terminal in the home network receives a home address of the first network protocol, the home address being represented in the first format;
processing, using the home computer, addresses of the first and the second network protocol, wherein the home computer assigns the home address which is represented in the second format to the terminal and the home address is converted into the first format in a conversion step;
receiving at the terminal a second address (CoA) of the second network protocol, the second address being represented in the second format, wherein the second address is the address in an external network outside of the home network if the terminal is situated in the external network; and
a data packet, including the address of the data source represented in the first format as a source address and the home address represented in the first format as a destination address, such that the adapted data packet includes the address of the home computer represented in the second format as a source address and the second address of the terminal represented in the second format as a destination address as well as the address of the data source represented in the second format as a further address.

9. The method as claimed in claim 8, in which the data packet which is adapted is transferred from the data source to the home computer and adapting step is performed by the home computer, wherein an assignment of the second address to the home address of the terminal is stored for the adapting step in the home computer.

10. The method as claimed in claim 8, in which the data packet which was adapted is changed such that the changed data packet includes the address of the data source represented in the first format as a source address and the home address represented in the first format as a destination address, wherein the address of the data source represented in the first format is determined from the further address of the data packet which was adapted.

11. The method as claimed in claim 10, in which the data packet which was adapted is transmitted via the data network to a data transmission device which is connected to the terminal and the changing of the data packed is performed by the data transmission device, wherein the data packet which was changed is then transmitted from the data transmission device to the terminal.

12. The method as claimed in claim 11, in which the data transmission device is connected to the terminal via a (point-to-point protocol) connection.

13. Method as claimed in claim 8, in which the first network protocol is IPv4 with or without Mobile-IPv4 support and the second network protocol is IPv6 with Mobile-IPv6 support, or in which the first network protocol is IPv6 with Mobile-Ipv6 support and the second network protocol is IPv4 with or without Mobile-IPv4 support.

14. The method as claimed in claim 13, in which the further address of the data packet which was adapted is stored in the routing header of the data packet.

15. A data transmission device for processing data packets which are transmitted in a data network which has a mobile function from a terminal to a data source via a home computer of the data network, wherein the terminal and the data source use a first network protocol, in which addresses of the first network protocol are assigned to the terminal and to the data source, the addresses being represented in a first format, and the data network uses a second network protocol, in which addresses of the second network protocol are assigned to the computers in the data network, the addresses being represented in a second format, wherein the addresses of the first network protocol can also be represented in the second format, wherein
the terminal is assigned to a home network, wherein the terminal in the home network receives a home address of the first network protocol, the home address being represented in the first format;
using the home computer, addresses of the first and the second network protocol are prcoessed, wherein the home computer assigns the home address which is represented in the second format to the terminal and the home address is converted into the first format in a conversion step;
at the terminal a second address of the second network protocol is received, the second address being represented in the second format, wherein the second address is the address in an external network outside of the home network if the terminal is situated in the external network; and
a data packet, including the home address represented in the first format as a source address and the address of the data source represented in the first format as a destination address, is adapted such that the adapted data packet includes the second address represented in the second format as a source address and the address of the home computer represented in the second format as a destination address as well as the address of the data source represented in the second format as a further address.

16. The data transmission device as claimed in claim 15, wherein the data transmission device is a mobile device.

17. A data network which has a mobile function for transmitting data between data sources and terminals, wherein the data network is configured to perform the following:
assigning the terminal to a home network, wherein the terminal in the home network receives a home address of the first network protocol, the home address being represented in the first format:
processing, using the home computer, addresses of the first and the second network protocol, wherein the home computer assigns the home address which is represented in the second format to the terminal and the home address is converted into the first format in a conversion step;
receiving at the terminal a second address of the second network protocol, the second address being represented in the second format, wherein the second address is the address in an external network outside of the home network if the terminal is situated in the external network; and
adapting a data packet, including the home address represented in the first format as a source address and the address of the data source represented in the first format as a destination address, such that the adapted data packet includes the second address represented in the second format as a source address and the address of the home computer represented in the second format as a destination address as well as the address of the data source represented in the second format as a further address.

18. The data network as claimed in claim 17, in which a part of the data network is the Internet.

19. The data network as claimed in claim 17, in which at least one of the home network and the external network His a wireless network which is based on GPRS and/or Wireless LAN and/or Bluetooth and/or UMTS and/or CDMA2000.
